(19) United States
(12) Patent Application Publication
(10) Pub. No.: US 2024/0013034 A1
(43) Pub. Date: Jan. 11, 2024

(54) NEURAL NETWORK PREDICTION SYSTEM FOR PRIVACY PRESERVATION

(71) Applicant: Univ. Electronic Science and Technology of China, Chengdu (CN)

(72) Inventors: Hongwei LI, Chengdu (CN); Haomiao YANG, Chengdu (CN); Meng HAO, Chengdu (CN); Jia HU, Chengdu (CN); Hanxiao CHEN, Chengdu (CN); Xinyuan QIAN, Chengdu (CN); Wenshu FAN, Chengdu (CN); Shuai YUAN, Chengdu (CN); Rui ZHANG, Chengdu (CN); Jiasheng LI, Chengdu (CN); Xiaolei ZHANG, Chengdu (CN)

(21) Appl. No.: 18/472,644

(22) Filed: Sep. 22, 2023

Related U.S. Application Data
(63) Continuation of application No. PCT/CN2023/083561, filed on Mar. 24, 2023.

(30) Foreign Application Priority Data
Jun. 10, 2022 (CN) 202210656199.8

(51) Int. Cl. G06N 3/048; H04L 9/08; H04L 9/30

(52) U.S. Cl. CPC G06N 3/048; H04L 9/0869; H04L 9/3073

(57) ABSTRACT

Disclosed is a privacy-preserving neural network prediction system in the technical field of information security. The system includes a client, a server and a third party device. Off-line, the client, the server and the third party complete model parameter sharing through negotiation. Online, the client sends/shares input data to the server. The client and the server use a secure calculating protocol to jointly execute neural network prediction with privacy preservation. The server returns an obtained prediction result to the client, and the client reconstructs the prediction result. Only one round of communication interaction is required, and the amount of communication overhead is reduced, so that the communication efficiency significantly improves. The calculations in the present system may be based on a ring, rather than a domain. The present system also (re)customizes the offline protocol, which improves the offline efficiency and requires only a lightweight secret sharing operation.

### RELATED APPLICATIONS

The present application is a continuation of International Pat. Appl. No. PCT/CN2023/083561, which claims priority to Chinese Pat. Appl. No. 202210656199.8, filed Jun. 10, 2022, the contents of each of which are incorporated by reference herein in their entireties.

### TECHNICAL FIELD

The present invention belongs to the technical field of information security, and particularly to a neural network prediction system adapted to preserve privacy.

### BACKGROUND

With the development of deep learning technology, neural network prediction techniques are being used in an increasing number of fields, such as image classification, medical diagnosis, and language assistants. Many Internet companies have opened up online prediction services, such as Google's ML Engine, Microsoft's Azure ML Studio, and Amazon's SageMaker, to help improve these applications. However, there are significant privacy concerns with the deep learning-based prediction systems currently in use. On the one hand, users must send input data containing private information to the service provider, which could result in the leakage of users' private information. On the other hand, if an alternative is used in which the service provider sends the neural network model or makes the neural network available to the user, the service provider's rights may be violated.

To address the foregoing privacy issues, researchers have proposed many solutions based on Homomorphic Encryption or Secure Two-party Computation, which guarantee that the service provider has no access to the user's private information, while the user cannot get any information from the service provider other than the prediction results. Although these solutions can guarantee privacy security, the expenses of calculation and communication are both very high.

### SUMMARY OF THE INVENTION

One objective of the present invention is to provide a privacy-preserving neural network prediction system, so as to achieve privacy preservation and guarantee protocol effectiveness without sacrificing model accuracy.

To achieve the above-mentioned purpose, the technical solution(s) adopted by the present invention may be as follows (herein, a word ending in “(s)” indicates that it may be singular or plural):

A neural network prediction system adapted to preserve privacy, comprising a client, a server, and a third party device. The client and the third party device may each independently comprise a mobile terminal, such as a mobile phone, a tablet or laptop computer, etc., or a desktop computer or workstation.

The client, the server and the third party device all include identical pseudorandom number generators.

The server includes a neural network configured to specify a prediction task, and the neural network comprises two different types of network layers, linear (e.g., one or more, and typically a plurality of, linear layers) and non-linear (e.g., one or more, and typically a plurality of, non-linear layers).

The client is configured to initiate a task prediction request to the server, and the server is configured to return to the client the hierarchical structure of the neural network and the type of a current network layer for a current task prediction (e.g., initiated by the task prediction request);

In an offline stage of the current task prediction (e.g., in or from the neural network), the client, the server, and the third party device are configured to share a model parameter W of the neural network.

Each of the client, the server, and the third party device generate pseudorandom seeds with the others of the client, the server, and the third party device to obtain a first seed seed_{cs} between the client and the server, a second seed seed_{c} between the client and the third party device, and a third seed seedₛ between the server a nd the third party device.

Each of the client, the server, and the third party device share the model parameter W as follows:
When the current network layer is a linear layer, the system performs the following:
   a) The client and the third party device respectively input the second seed seed_{c} (a current second seed) into the pseudorandom number generator (e.g., in either or both of the client and the third party device) to generate a first pseudorandom number a; either or both of the client and the third party device update the second seed seed_{c} according to an agreed updating strategy, and then either or both of the client and the third party device input the updated second seed seed_{c} into the pseudorandom number generator to generate a second pseudorandom number [ab]₀; in some embodiments, the second seed seed_{c} is updated in accordance with the agreed updating strategy each time the client and the third party device input the second seed seed_{c} into the corresponding pseudorandom number generator(s);
   b) The server and the third party device respectively input the third seed seedₛ (a current third seed seedₛ) into the pseudorandom number generator (e.g., in either or both of the server and the third party device) to generate a third pseudorandom number b; in some embodiments, the third seed seedₛ is updated in accordance with the agreed updating strategy each time the server and the third party device input the third seed seedₛ into the corresponding pseudorandom number generator(s);
   c) The third party device calculates first and second sharing parameters [ab]₁ and ab of the linear layer from a, b and [ab]₀ (e.g., [ab]₁=ab−[ab]₀) and sends a result (e.g., of the calculation) to the server; in some embodiments, the linear layer corresponds to the first sharing parameter [ab]₁;
   d) The client and the server respectively input the first seed seed_{cs} (a current first seed seed_{cs}) into the pseudorandom number generator (e.g., in either or both of the client and the server) to generate a fourth pseudorandom number r′; in some embodiments, the first seed seed_{cs} is updated in accordance with the agreed updating strategy each time client and the server input the first seed seed_{cs} into the corresponding pseudorandom number generator(s);
   e) The client calculates a random number r from a and the pseudorandom number r′ (e.g., r=r′−a mod N, where N represents a size of a ring Z_{N}); and
   f) The server sends a value W−b to the client, the client locally calculates a first parameter from W, r, b, [ab]₀ and N (e.g., the first parameter [Wr]₀=(W−b)r−[ab]₀ mod N), and the server locally calculates a second parameter from r′, b and [ab]₁ (e.g., the second parameter [Wr]₁=br′−[ab]₁).

That is, at the client, each linear layer of the neural network corresponds to one first parameter ([Wr]₀); at the server, each linear layer of the neural network model corresponds to one second parameter ([Wr]₁).
When the current network layer is a nonlinear layer, the system performs the following:
   1) The third party device generates a key pair (k₀, k₁) according to an agreed function secret sharing strategy, and sends a first key k₀ of the key pair to the client and a second key k₁ of the key pair to the server, wherein:
      i) the first key k₀ comprises a second random number [\tilde{r}]₀ jointly generated by the third party device and the client based on the second seed seed_{c} (e.g., the current second seed seed_{c}),
      ii) the second key k₁ comprises a random number [\tilde{r}]₁ jointly generated by the third party device and the server based on the third seed seedₛ (the current third seed seedₛ),
      iii) the random numbers [\tilde{r}]₀ and [\tilde{r}]₁ may comply with or conform to an equation \tilde{r}=[\tilde{r}]₀+[\tilde{r}]₁ mod N, and
      iv) the function secret sharing strategy comprises a key generation strategy of probabilistic polynomial time and an evaluation strategy of polynomial time, wherein:
         A) the key pair (k₀, k₁) may be generated using the key generation strategy, and
         B) an input (e.g., to the neural network and/or the prediction task) may be evaluated using the evaluation strategy; and
   2) In an online stage of the prediction task using the neural network, the client and the server jointly execute a forward inference operation (e.g., an input data definition operation) based on sharing the model parameter W at the offline stage by:
      i) The client divides or separates to-be-predicted data x into two parts according to a configured secret sharing equation x=[x]₀+[x]₁ mod N, and sends [x]₁ to the server, and
      ii) The forward inference operation of each layer (e.g., each non-linear layer, each linear layer, or each linear and non-linear layer) of the neural network model comprises:
         A) Defining [\tilde{x}]₀ to represent input data of each (linear and/or non-linear) layer of the client, wherein the input data of a first (linear or non-linear) layer of the client [\tilde{x}]₀=[x]₀, and
         B) Defining [\tilde{x}]₁ to represent input data of each (linear or non-linear) layer of the server, where in the input data of a first layer of the server [\tilde{x}]₁=[x]₁.

For the linear layer(s), the forward inference operation may further include:
a. The client sends [\tilde{x}]₀−r mod N to the server, and the server extracts input data [\tilde{x}]₀,
b. The client calculates a first output [y]₀=[Wr]₀ of a current (linear or non-linear) layer (e.g., at or of the client), and takes [y]₀ as input data [\tilde{x}]₀ of a next (linear or non-linear) layer of the client, and
c. The server reconstructs data (e.g., \tilde{x}−r=[\tilde{x}]₀−r+[\tilde{x}]₁ mod N) of a current (linear or non-linear) layer (e.g., at or of the server), calculates a second output [y]₁=[Wr]₁+W(\tilde{x}−r)mod N of the current layer (e.g., at or of the server), and takes the second output [y]₁ as input data [x]₁ of a next (linear or non-linear) layer of the server.

For the non-linear layer(s), the forward inference operation may further include:
a. The client sends [\tilde{x}]₀+[\tilde{r}]₀ mod N to the server;
b. The server sends [\tilde{x}]₁+[\tilde{r}]₁ mod N to the client; and
c. The client and the server respectively reconstruct the data of the respective current layer in accordance with the equation \tilde{x}+\tilde{r}=[\tilde{x}]₀+[\tilde{r}]₀+[\tilde{x}]₁+[\tilde{r}]₁ mod N.

The client may obtain the first output [y]₀ of the current layer (e.g., at or of the client) using the evaluation strategy of the agreed function secret sharing strategy based on the data \tilde{x} and \tilde{r} and a secret key k₀, and may take [y]₀ as the input data [\tilde{x}]₀ of the next layer of the client.

The server may obtain the second output [y]₁ of the current layer (e.g., at or of the server) using the evaluation strategy of the agreed function secret sharing based on the data \tilde{x} and \tilde{r} and a secret key k₁, and may take [y]₁ as the input data [\tilde{x}]₁ of the next layer of the server.

When the forward inference operation is carried out on a last layer (e.g., the output layer) of the neural network, the server may return the second output [y]₁ of the last layer to the client. The client may obtain a final prediction result based on the second output [y]₁ of the last layer from the server and the first output [y]₀ of the last layer calculated by the client, wherein y=[y]₀+[y]₁.

Further, the third party device may generate the key pair (k₀, k₁) based on the agreed function secret sharing policy. Specifically, a key pair generation operation may include:
The client and the third party device respectively generate a random number [\tilde{r}]₀ using one or more of the pseudorandom number generators (e.g., the respective pseudorandom number generators) based on the second seed seed_{c} (e.g., the current second seed seed_{c});
The server and the third party device respectively generate a random number [\tilde{r}]₁ using one or more of the pseudorandom number generators (e.g., the respective pseudorandom number generators) based on the third seed seedₛ (e.g., a current third seed seedₛ);
The third party device calculates \tilde{r}=[\tilde{r}]₀+[\tilde{r}]₁ mod N;
The third party device defines parameters b″, a′ and b′ (e.g., b″=(1, −\tilde{r}), a′=\tilde{r}, b′=(−1, \tilde{r})), and generates the key pair (k₀, k₁) using a′ and b′ as inputs to an agreed generation function (e.g., an agreed key pair generation function), wherein b″, b′∈ [symbol] _{N}× [symbol] _{N};
The third party device selects a first random value b₀ (e.g., b₀∈ [symbol] _{N}× [symbol] _{N}) and obtains a second random value b₁ (e.g., b₁∈ [symbol] _{N}× [symbol] _{N}), according to an equation b₀+b₁=b″∈ [symbol] _{N}× [symbol] _{N};
The third party device generates the key pair (k₀, k₁), wherein k₀=k′₀∥[\tilde{r}]₀∥b₀ and k₁=k′₁∥[\tilde{r}]₀∥b₁, and sends the key pair (e.g., k₀ and k₁) to the client and the server, respectively.

Further, the client and the server may respectively obtain the output (e.g., the first and/or second output) of the current layer (e.g., a respective current linear or non-linear layer) using the evaluation strategy in the agreed function secret sharing strategy. Specifically, an evaluation operation in the agreed function secret sharing strategy may include:
1) The client and the server may respectively calculate one or more sharing values (e.g., ω_{0,p} and ω_{1,p}) of the model parameter(s) of at least one of the current layers based on an agreed equation or algorithm (e.g., the configured secret sharing equation), wherein p∈{0,1}, as follows:
   i) The client obtains first sharing values (e.g., ω_{0,0} and ω_{1,0}) based on an evaluation function of polynomial time (e.g., Eval_{a,b′}(k′₀, \tilde{x}+\tilde{r})+b₀), and
   ii) The server obtains second sharing values (e.g., ω_{0,1} and ω_{1,1}) based on a similar or identical evaluation function of polynomial time (e.g., Eval_{a,b′}(k′₁, \tilde{x}+\tilde{r})+b₁); and
2) The client and the server may respectively calculate the first output [y]₁ of the client and the second output [y]₁ of the server (e.g., according to an equation [y]ₚ=ω_{0,p}(\tilde{x}+\tilde{r})+ω_{1,p}).

The technical solutions provided by the present invention bring at least the following beneficial effects.

The present invention not only can effectively protect the privacy of data of a client, but also the parameter information of a network or network model in a server, and the calculation efficiency is high. The nonlinear layer protocol based on the present specification (e.g., data interaction in the non-linear layer[s]) significantly reduces communication costs.

### DESCRIPTION OF DRAWINGS

To describe the technical solutions in the embodiments of the present specification more clearly, the following briefly introduces the drawings for describing the embodiments. The drawings described below may represent only some embodiments of the present specification, and other drawings can be obtained according to these drawings by persons skilled in the art without creative labor.

FIG. 1A is a schematic diagram of one or more principles of a privacy-preserving neural network prediction system in accordance with one or more embodiments of the present specification.

FIG. 1B shows an example of a federated and/or iterative learning system and process suitable for use in the present invention.

FIG. 2 is a diagram of a comparison function and/or protocol (e.g., Gen_{a,b}^{<}; that is, a secret key generation and/or calculation process in the comparison function) in accordance with one or more embodiments of the present specification.

FIG. 3 is a diagram of a comparison function and/or protocol (e.g., Eval_{a,b}^{<}; that is, an evaluation and/or calculation process in the comparison function) in accordance with one or more embodiments of the present specification.

FIG. 4 is a diagram of an activation function and/or protocol (e.g., of Gen_{a,b}^{ReLU} in a ReLU protocol; that is, a secret key generation in an activation function) in accordance with one or more embodiments of the present specification.

FIG. 5 is a diagram of another activation function and/or protocol (e.g., of Eval_{a,b}^{ReLU} in a ReLU protocol; that is, an evaluation and/or calculation process in the activation function) in accordance with one or more embodiments of the present specification.

FIG. 6 is a schematic diagram of components in the system and/or of processing in an offline stage in accordance with one or more embodiments of the present specification.

FIG. 7 is a schematic diagram of components in the system and/or of processing in an online stage in accordance with one or more embodiments of the present specification.

### DETAILED DESCRIPTION

Various embodiments are further described below in detail in the present specification in combination with the attached drawings to make the purpose(s), technical solutions and advantages of the present invention clearer. To solve the privacy-preserving concerns of online prediction service based on neural networks, Mishra et al. put forward the Delphi framework, which divides the whole prediction process into an offline stage unrelated to input and an online stage related to input, and introduces a cryptographic protocol into the neural network model. Also, some algorithms are designed to transfer the time-consuming cryptographic operations from the online stage to the offline stage as much as possible. Thus, the efficiency of the online stage can be greatly improved. However, there is still a problem in the Delphi framework. The overhead of the nonlinear layer is several orders of magnitude greater than that of the linear layer. This is because calculating a function based on garbled circuits may require decomposing the function into a binary gate circuit, the processing the function and/or the binary gate circuit bit-by-bit in ciphertext form. For example, after the Delphi framework is adopted, the activation function and/or operation ReLU in the training process of a Resnet32 model accounts for 93% of the execution time in the online phase. Although some optimizations for ReLU have emerged in recent work, these solutions either cannot be disassembled directly into online and offline stages, or require more rounds of communication or special secret-sharing primitives.

The purpose(s) of embodiments of the present invention include enhancing the neural network prediction system, so as to achieve privacy preservation and/or guarantee protocol efficiency, without sacrificing accuracy of the prediction and/or model. Specifically, purpose(s) of embodiments of the invention are as follows:
1) Privacy preservation. The input of the client contains sensitive information, and the server (or the model on the server) is an important asset that should not be leaked during the prediction process.
2) Efficient evaluation. The additional calculation and communication overhead of the solution should be moderate but not too high, which is especially important in real-time scenarios or in situations where resources are limited.
3) Prediction accuracy. Compared with a prediction task without privacy preservation, the protocol (a security calculation protocol) should not sacrifice accuracy of prediction, especially when it is applied to critical scenarios such as medical treatment.

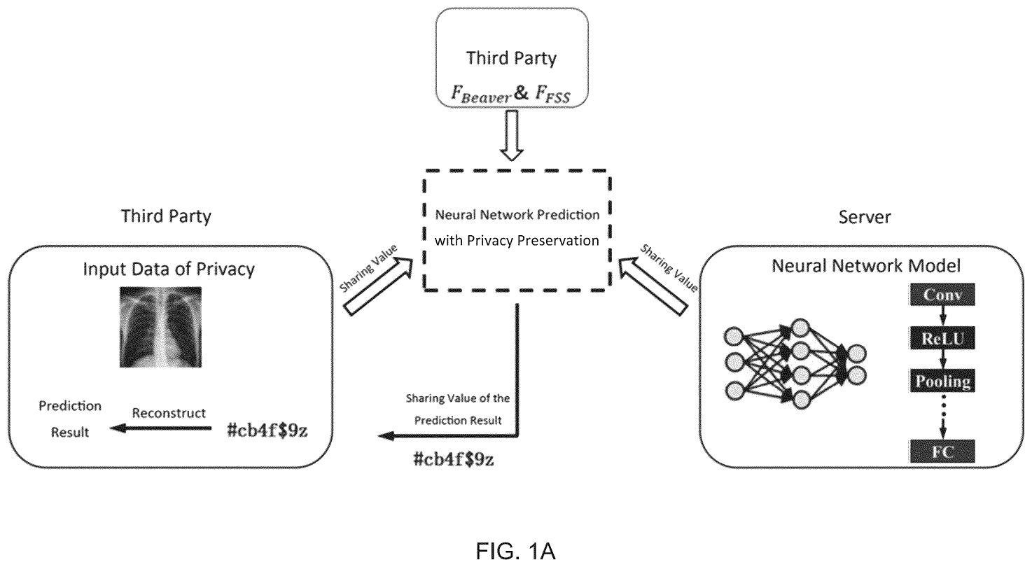

As shown in FIG. 1A, the present privacy-preserving neural network prediction system and/or model provided by embodiments of the present specification comprise(s) a client and a server (also referred to as a server side), wherein the server holds a neural network or neural network model M and a model parameter ω, and the client holds a private data sample x (such as image data, text data, audio data, etc.). An objective of the client is to obtain a prediction output from the neural network and/or of the model corresponding to the private data as an input (i.e., M(ω, x)), and at the same time, the server side does not obtain any information input by the client in this process. For example, a patient who has his own chest X-ray can, with the help of the present system and method, obtain a predicted result (e.g., that enables one to determine whether the patient has a disease), without leaking the chest X-ray.

As shown in FIG. 1A, the present prediction process and/or system can be summarized in three steps:
1) The client sends input data x to and/or shares input data x with the server;
2) The client and the server jointly execute the prediction with privacy preservation using the neural network and/or a secure calculating protocol; and
3) The server returns a shared value of the prediction to the client, and the client reconstructs the shared value to get the prediction result.

In FIG. 1A, F_{Beaver} represents a function for generating a multiplicative triple, F_{FSS} represents function secret sharing, “#cb4f9z” represents a shared value of a prediction (e.g., the “sharing value of the prediction result”), Conv represents the convolutional layer, ReLU represents the activation function, Pooling represents the pooling layer, and FC represents the fully-connected layer.

The present invention may also employ a federated and/or iterative learning system and process. An example 100 of a federated and/or iterative learning system and process suitable for the present invention is shown in FIG. 1B. For example, at 110, the client (e.g., each of the clients 115a-115l) downloads a global model Wₜ₋₁ from the server 140. The client(s) 115a-115l train local data using a neural network 120a-120n to obtain a local model W_{t,k} (e.g., the local model update of the k-th client's t-th round or cycle of communication, where each of k and t is an integer of 1 or more, typically 2 or more; t may be relatively large, such as ≥10, ≥20, ≥50, ≥100, etc.).

From left to right in FIG. 1B, each neural network 120a-120l comprises a plurality of layers 122a-122c. Essentially, each column in the neural network 120a-120n is a layer 122 of the neural network. The neural networks 120a-120n generally include an input layer 122a, one or more hidden layers 122b, and an output layer 122c. In general, each of the input layer 122a, hidden layer(s) 122b, and output layer 122c includes a plurality of nodes. The paths from each node of the input layer 122a to each node of the hidden layer(s) 122b are independently assigned a weight Wᵢⱼ, and these weights may be changed or adjusted during iterative learning. In some embodiments, the hidden layer(s) 122b in each neural network 120a-120n contain a larger number of nodes than the output layer 122c.

At 130, each client 115a-115l uploads their respective local model W_{t,k} to the server 140, thereby effectively updating the local models W_{t,1} through W_{t,k:1} in the server 140. The server 140 then performs a weighted aggregation operation after receiving the local models W_{t,k} (i.e., data) from all of the clients 115a-115l to obtain the global model Wt (e.g., an updated global model, of or following the t-th round or cycle of communication between the server 140 and the clients 115a-115l).

The basic process involved in the cipher protocol of one or more embodiments of the present specification is as follows:
1) Secret sharing: In various embodiments of the present specification, a lightweight additive secret sharing based on a ring [symbol] _{N} may be adopted. Share(x) may represent a sharing function or process, which takes an n-bit value x as input and outputs two random values [x₀] and [x₁]. In general, x=[x₀]+[x₁] may be satisfied in ring [symbol] _{N}. Recon([x₀], [x₁]) may represent a reconstruction function or process, taking [x₀], [x₁] as an input and outputting x=[x₀]+[x₁]mod N. The security of additive secret sharing is guaranteed in that only one of [x₀], [x₁] is given, and the original data x cannot be reconstructed.
2) Function secret sharing (FSS): Function secret sharing is an efficient process, which decomposes a function ƒ into two sharing functions (e.g., ƒ₀, ƒ₁) and satisfies ƒ₀(x)+ƒ₁(x)=ƒ(x) for any x. In this way, the original function ƒ can be well hidden and not easily leaked. A two-party function secret sharing solution may comprise two parts: Gen and Eval. The main functions of the two parts are as follows:
   i) Gen(1^{κ}, ƒ) is a key generation function of probabilistic polynomial time, with the input being a security parameter κ and a function ƒ, that outputs a pair of keys (k₀, k₁), each of which implicitly represents a function ƒₚ: [symbol] _{N}→ [symbol] _{N}.
   ii) Eval(p, kₚ, x) is a polynomial time evaluation function. The input is a participant number p, a key kₚ and a public input x∈ [symbol] _{N} of a participant, and that outputs yₚ∈ [symbol] _{N}; i.e., for ƒₚ(x), ƒ(x)=ƒ₀(x)+ƒ₁(x).
   iii) Based on existing work, the function secret sharing solution may evaluate input sharing after a certain conversion. The key to constructing a function secret sharing solution is the offset function ƒᵣ(x)=ƒ(x−r), where r is a random number in the ring [symbol] _{N} that is held by both parties (e.g., the client and the server, in the form of secret sharing). Each party holding the shared value of the input x first discloses the input x+r by adding a mask, and then uses x+r as the input of ƒᵣ(x) to calculate the key pair (e.g., of the function secret sharing solution), which is equivalent to generating the key pair by using x as the in put of ƒ(x), that is, ƒᵣ(x+r)=ƒ(x).
3) Pseudorandom number generation: The input of the pseudorandom number generator may comprise an average sampled random seed and a security parameter κ, and the output may comprise a long string of pseudorandom numbers. The security of the pseudorandom number generator is guaranteed in that the output and uniform distribution of the generator are indistinguishable within polynomial time, as long as the random seed does not leak. In one or more embodiments of the present specification, the pseudorandom number generator ensures that the two parties can generate the same pseudorandom number without communication or other interaction with each other.

Based on the foregoing technologies, in embodiments of the present specification, the following protocols are constructed and/or followed for non-linear operations:
1) Comparison protocol: The comparison operation in embodiments of the present specification is a basic operation, and is usually considered to be a non-linear function. For example, the comparison operation is typically used in the implementation of ReLU and Maxpool. One may assume that the comparison operation function is:

$${f}_{a , b}^{<} ( x ) = \{ \begin{matrix}b & ( x < a ) \\ 0 & ( x \geq a )\end{matrix}$$

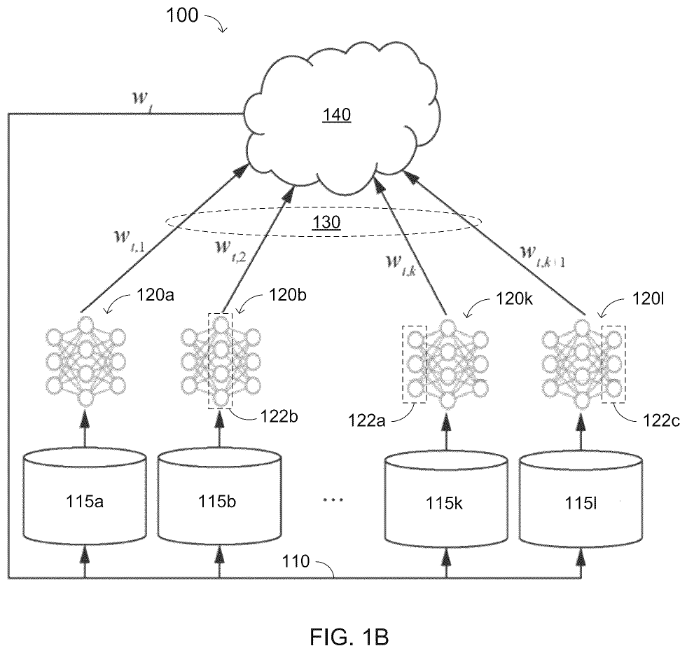

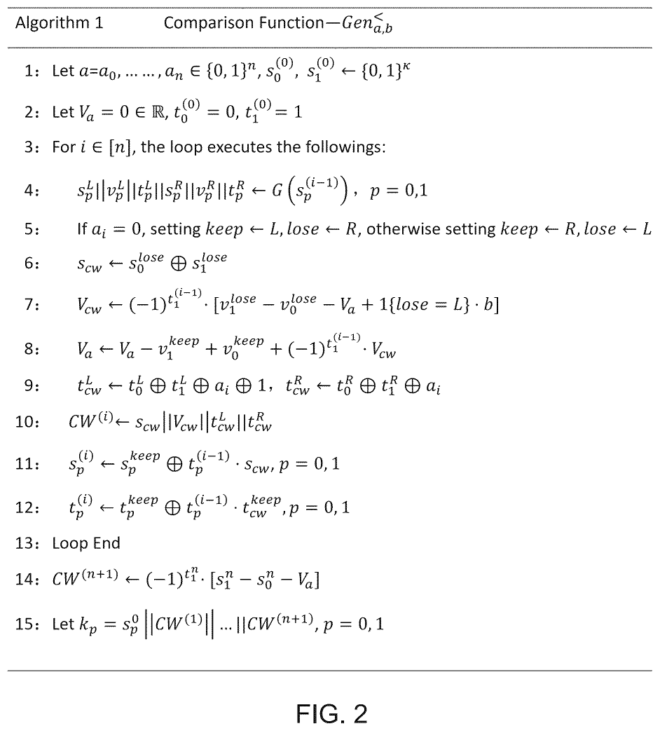

i) In embodiments of the present specification, f_{a,b}^{<}(x) may comprise two parts, Gen_{a,b}^{<} and Eval_{a,b}^{<} (as shown in FIGS. 2 and 3). Gen_{a,b}^{<} is a process that generates a key pair (k₀, k₁). Each key k₀ and k₁ in the key pair represents a binary tree. The binary tree has leaf nodes with labels that are determined by the input x∈{0, 1}ⁿ. The number of leaf nodes may be 2ⁿ. The term {0,1}ⁿ may represent a character string composed of one or more 0's and one or more 1's and having a length of n. The path from a root node to a leaf node (e.g., of each binary tree) marked by x is referred to as an evaluation path, and the evaluation path representing a is referred to as a special path. Each node on the binary tree contains a tuple (sₚ, vₚ, tₚ), where p∈(0,1) and represents a participant number, sₚ is a random seed of the pseudorandom number generator, vₚ is an output in the ring, and tₚ is a control bit. The Eval_{a,b}^{<} process calculates labels of all the nodes on the evaluation path corresponding to the input x using the seed of the root node as the initial seed.
ii) A specific calculation process of Gen_{a,b}^{<} in the comparison function is shown in FIG. 2, when the participants A and B (corresponding to the client and the server of the present system) execute the Gen_{a,b}^{<} algorithm at the same time:
   A) For the Gen_{a,b}^{<} input data a ({0,1}ⁿ) of the comparison function, n represents the byte length of a. Dividing or separating a into n one-bit values (e.g., a₀, . . . , aₙ∈{0, 1}ⁿ), the two participants respectively initialize the random seed to s₀⁽⁰⁾), s₀⁽⁰⁾←{0,1}^{κ} for the root node (labeled as 0), the control bits t₀⁽⁰⁾=0, t₁⁽⁰⁾=1, and Vₐ to 0. In FIG. 2, [symbol] represents the real number field, the subscripts “0” and “1” are used to distinguish the two participants, and the superscripts of random seeds and control bits are used to indicate the node number.
2) For each node i, the two participants respectively use sₚ⁽ⁱ⁻¹⁾ as a random seed to generate a pseudorandom number sequence: sₚ^{L}∥vₚ^{L}∥tₚ^{L}∥sₚ^{R}∥vₚ^{R}∥tₚ^{R}←G(sₚ⁽ⁱ⁻¹⁾) where p=0,1;
3) If aᵢ=0, set keep←L, lose←R, otherwise set keep←R, lose←L, and calculate s_{cw}←s₀^{lose}⊕s₁^{lose};
4) Then the two participants successively calculate V_{cw}←(−1)^{t}^{₁}^{^{(i−1)}}·[v₁^{lose}−v₀^{lose}−Vₐ+1{lose=L}·b], Vₐ←Vₐ−v₁^{keep}+v₀^{keep}+(−1)^{t}^{₁}^{^{(i−1)}}·V_{cw}, t_{cw}^{L}←t₀^{L}⊕t₁^{L}⊕aᵢ⊕1, and t_{cw}^{R}←t₀^{R}⊕t₁^{R}⊕aᵢ;
5) The two participants construct CW⁽ⁱ⁾←s_{cw}∥V_{cw}∥t_{cw}^{L}∥t_{cw}^{R}, and calculate sₚ⁽ⁱ⁾←sₚ^{keep}⊕tₚ⁽ⁱ⁻¹⁾·s_{cw}, tₚ⁽ⁱ⁾←tₚ^{keep}⊕tₚ⁽ⁱ⁻¹⁾·t_{cw}^{keep}, where p=0, 1;
6) After calculating the first n nodes, the two participants construct CW⁽ⁿ⁺¹⁾←(−1)^{t}^{₁}^{ⁿ}·[s₁ⁿ−s₀ⁿ−Vₐ].

By following the above protocols for non-linear operations, the two participants respectively construct keys kₚ=sₚ⁰∥CW⁽¹⁾∥ . . . ∥CW⁽ⁿ⁺¹⁾, where p=0, 1.

A specific calculation process of the comparison function Eval_{a,b}^{<} is shown in FIG. 3, in which the participants A and B execute the Eval_{a,b}^{<} function at the same time:
1) The two participants respectively decompose the key kₚ=sₚ⁰∥CW⁽¹⁾∥ . . . ∥CW⁽ⁿ⁺¹⁾, initialize the control bit of node 0: t⁽⁰⁾=p, initialize V=0∈ [symbol] , and divide or separate the input x into n one-bit values: x₀, . . . , xₙ;
2) For each node i, the two participants decompose CW⁽ⁱ⁾=s_{cw}∥V_{cw}∥t_{cw}^{L}∥t_{cw}^{R}, G(s⁽ⁱ⁻¹⁾)=s^{L}∥v^{L}∥t^{L}∥s^{R}∥v^{R}∥t^{R};
3) The two participants then calculate s^{L}∥t^{L}∥s^{R}∥t^{R}←s^{L}∥t^{L}∥s^{R}∥t^{R}⊕t⁽ⁱ⁻¹⁾·[s_{cw}∥t_{cw}^{L}∥s_{cw}∥t_{cw}^{R}];
4) If xᵢ=0 for one or both of the two participants, the corresponding participant(s) calculate V←V+(−1)^{p}·[v^{L}+t⁽ⁱ⁻¹⁾·V_{cw}] and set a left sub-node of a current node i as a next node; otherwise, the participant(s) calculate V←V+(−1)^{p}·[v^{R}+t⁽ⁱ⁻¹⁾·V_{cw}] and set a right sub-node of the current node i as the next node; and
5) Finally, the two participants calculate V←V+(−1)^{p}·[s⁽ⁿ⁾+t⁽ⁿ⁾·CW⁽ⁿ⁺¹⁾].

The meanings of the related symbols in the Gen_{a,b}^{<} and Eval_{a,b}^{<} processes and/or functions are as follows:
(sₚ, vₚ, tₚ): p∈(0, 1) and represents the participant number, sₚ is the random seed of the pseudorandom number generator, vₚ is the output in or of the ring, and tₚ is the control bit. Each node in the binary tree corresponds to a tuple; for example, (sₚ⁽ⁱ⁾, vₚ⁽ⁱ⁾, vₚ⁽ⁱ⁾) represents the triplet corresponding to the node i of the participant p. In addition, the superscript L or R of sₚ, vₚ, tₚ represents a left or right child node of the current node.
a, b: the inherent parameter of the algorithm. aᵢ represents the i^{th} bit of the n-bit binary number a. The Gen_{a,b}^{<} process and/or function combined with the Eval_{a,b}^{<} process and/or function results in the following function: if the input is less than a, output b; otherwise, output 0.
CW: Correction Words. The superscript of CW represents the node number to which it belongs.
kₚ: the key obtained by the participants p after the process and/or function is executed.
G(sₚ⁽ⁱ⁻¹⁾): uses sₚ⁽ⁱ⁻¹⁾ as the random seed to generate a pseudorandom number, that is, G( ) represents the pseudorandom number generator.
V, Vₐ, V_{cw}: used to record and calculate the output.

It should be noted that, in embodiments of the present specification, the comparison protocol ideally satisfies the following conditions:
a) For any node not on the special path, two random seeds held by the node are the same;
b) For any node on the special path, its two control bits are different, and its two random seeds are indistinguishable;
c) The sum of v₀+v₁ of all nodes on the evaluation path corresponding to the input x is exactly equal to f_{a,b}^{<}(x).

In order to satisfy the foregoing conditions, Gen_{a,b}^{<} generates a series of correction words (CW). When an evaluation path corresponding to an input x is generated in the execution of Eval_{a,b}^{<}, if the generated evaluation path deviates from the special path, then the two random seeds s₀, s₁ held by the first node j on the evaluation path (which is not on the special path) are the same. In addition, if node j is on the right side of the special path (i.e., x>a), then the sum of all the v₀+v₁ from the root node to node j is 0. Otherwise, the sum is b.

ReLU Protocol: ReLU is a commonly used activation function in deep learning models. In the integer ring, ReLU may be expressed as follows:

$$ReLU ( x ) = \{ \begin{matrix}x ( 0 \leq x < \frac{N}{2} ) \\ 0 ( \frac{N}{2} \leq x < N )\end{matrix}$$

Since the calculation of the ReLU in the function secret sharing solution is based on input sharing, an offset function ReLUᵣ(x)=ReLU(x−r) may optimally be set, so that when x+r is input, the output result is exactly ReLU(x) (that is, ReLUᵣ(x+r)=ReLU(x)). In this way, ReLUᵣ(x) can be expressed as the equation below:

$${ReLU}_{r} ( x ) = \{ \begin{matrix}x ( r \leq x + r < r + \frac{N}{2} ) \\ 0 {( 0 \leq x + r < r , r + \frac{N}{2} \leq x + r < N )}^{°}\end{matrix}$$

However, when r is relatively large, a case where

$$r + \frac{N}{2} > N$$

may occur, which may cause problems in the evaluation process. It is readily conceivable to solve the problem by calling the comparison function twice, but this may lead to additional overhead. The optimization solution used in embodiments of the present specification may call the comparison function only once, and one example may be expressed as the equation below:

$${ReLU}_{r} ( x ) = \{ \begin{matrix}x ( x + r mod N \geq r ) \\ 0 ( x + r mod N < r )\end{matrix} ,$$

The error probability of this solution is

$$P \{ 1 \{ x < \frac{N}{2} \} \neq 1 \{ x + r mod N \geq r \} \} = \frac{\vert x \vert}{N} ,$$

whereas usually |x|<<N. For example, when N is a 32-bit integer, the selected integer x is only 12 bits, and the error probability is only one in a million. In addition, the tolerance to errors in the neural network prediction method is very high, and the evaluation result(s) also demonstrate that the influence of this solution on the accuracy of the method and/or model can be neglected.

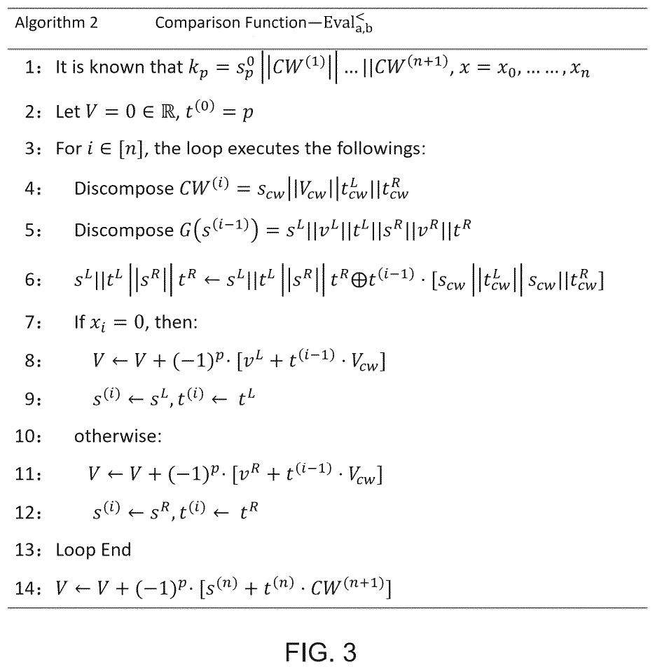

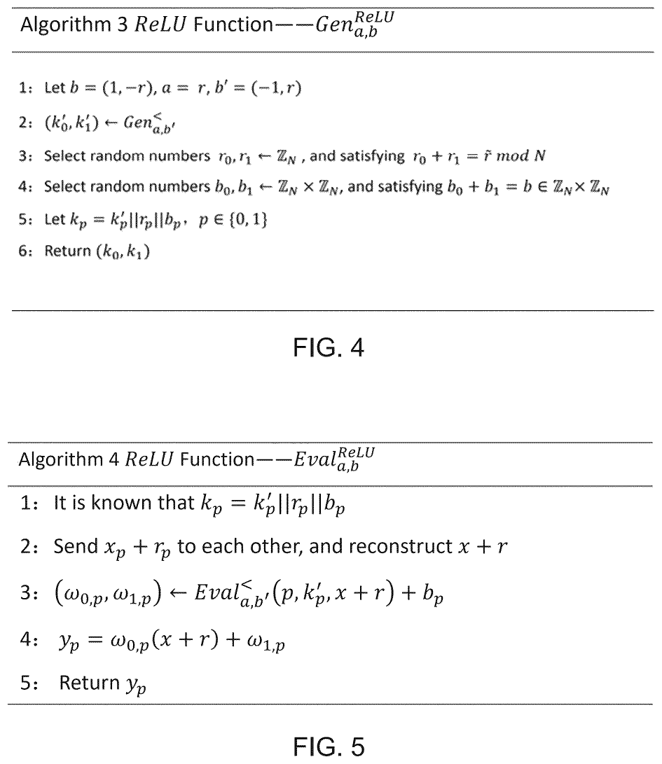

Based on the foregoing idea, embodiments of the present specification may set an efficient function secret sharing protocol for the ReLUᵣ function, and the protocol may include two parts: Gen_{a,b}^{ReLU} and Eval_{a,b}^{ReLU} (as shown in FIGS. 4 and 5). Two tips are involved in the function secret sharing protocol:
a) The actual function in the protocol is

$${f}_{a , b}^{\geq } ( x ) = \{ \begin{matrix}b ( x \geq a ) \\ 0 ( x < a )\end{matrix} ,$$

which can be converted by the existing ƒ_{a,b}^{<}(x) function to another function or form: ƒ_{a,b}^{≥}(x)=b+ƒ_{a,-b}^{<}(x);
b) The actual output in the protocol is a polynomial (for example, an offset function g(x)=x−r). In such a case, one may then let b=(ω₀, ω₁)=(1, −r) represent the polynomial ƒ(x)=x−r and b=(ω₀, ω₁)=(0, 0) represent ƒ(x)=0, so that the two parties performing the protocol can share ReLU(x) by locally calculating [ω₀](x+r)+[ω₁].

A specific calculation process of the Gen_{a,b}^{ReLU} activation function is shown in FIG. 4. The Gen_{a,b}^{ReLU} process and/or function may be executed by the third party device according to the following steps:
1) Letting b=(1, −r), a=r, b′=(−1, r),
2) Taking a random number r₀∈ [symbol] _{N}, b₀∈ [symbol] _{N}× [symbol] _{N}, obtaining the random number [r]₁ according to [r]₀+[r]₁=\tilde{r} mod N and the random value b₁∈ [symbol] _{N}× [symbol] _{N} according to b₀+b₁=b; and
3) Separately constructing the key kₚ=k′ₚ∥rₚ∥bₚ, where p=0, 1.

A specific calculation process of the Eval_{a,b}^{ReLU} activation function is shown in FIG. 5. The participants A and B may execute the following Eval_{a,b}^{ReLU} process and/or function simultaneously:
1) Using the de-encryption key kₚ=k′ₚ∥rₚ∥bₚ, the participants A and B send xₚ+rₚ (p=0, 1) to each other to reconstruct x+r;
2) The participants calculate Eval_{a,b′}^{<}(p, k′ₚ, x+r)+bₚ to obtain (ω_{0,p}, ω_{1,p});
3) The participants calculate yₚ=ω_{0,p}(x+r)+ω_{1,p}.

The meanings of related symbols involved in the Gen_{a,b}^{ReLU} and Eval_{a,b}^{ReLU} processes and/or functions are as follows:
a, b, b′, r: the inherent parameter of the algorithm for the generation of polynomials.
(ω₀, ω₁): the shared model parameters used to reconstruct polynomials for output.
k′ₚ, kₚ: k′ₚ represents a part of the key of the participant p, and kₚ represents the whole key of the participant p.
x+r: the actual input of the function.
yₚ: the key obtained by the participants p

The basic Maxpool algorithm is used to calculate a maximum value among d numbers x₁, x₂, . . . , x_{d}. In embodiments of the present specification, a Maxpool protocol may be set and/or based on function secret sharing, and the protocol participants may arrange the d numbers into a binary tree with a depth of log d. The protocol participants may then perform pairwise comparison recursively. The comparison may be expressed as max([xᵢ], [xⱼ])=ReLU([xᵢ], −[xⱼ])+[xⱼ], where xᵢ and xⱼ represent the two objects being compared.

In embodiments of the present specification, the prediction method is separated or divided into an offline stage and an online stage. The main purpose is to reduce the overhead of the online stage, especially the overhead of the non-linear layer.

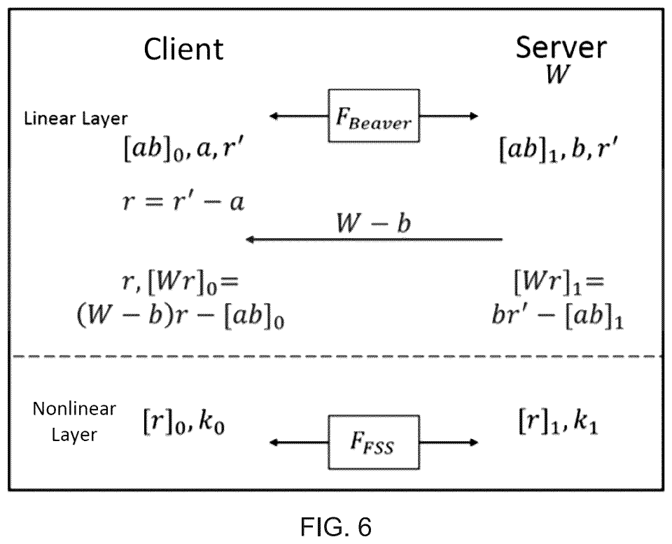

A flow of the offline stage is shown in FIG. 6, which mainly includes the following parts:
1) Initialization: introducing a third party device, the pseudorandom seeds are generated in pairs between the client, the server and the third party device, so as to obtain first through third seeds: seed_{cs}, seed_{c}, and seedₛ.
2) Linear layer: the main purpose thereof is to calculate and/or share (e.g., calculate the sharing of) W and r, where W is a model parameter stored in or generated by the server, and r is a random number selected or generated by the client. A specific operation or flow of the linear layer is as follows:
   i) The third party device generates a multiplicative triple (Beaver's triple) (a, b, ab). Specifically, the client and the third party device may use the second seed seed_{c} to generate a, [ab]₀ jointly, and the server and the third party device may use the third seed seeds to generate b jointly. Finally, the third party device calculates[ab]₁=ab−[ab]₀ and sends the result to the server.
   ii) The client and the server may use the first seed seed_{cs} to generate r′ jointly, the client calculates r=r′−a mod N, and the server sends W−b to the client. Finally, the client and the server respectively calculate [Wr]₀=(W−b)r−[ab]₀ mod N, [Wr]₁=br′−[ab]₁ locally.
3) Non-linear layer: the third party device generates a key pair using a function secret sharing solution, and distributes the key to the client and the server. Taking the calculation of the ReLU function as an example, the calculation manner of the Maxpool function and/or process is also similar. A specific operation process is as follows:
   i) The third party device may generate [r]₀, [r]₁ respectively using the second seed seed_{c} and the third seed seedₛ. The client and the server may also obtain [r]₀ and [r]₁ respectively. The third party device calculates \tilde{r}=[r]₀+[r]₁ mod N, and then generates a key pair (k₀, k₁) using the Gen_{a,b}^{ReLU} function and/or process and distributes the key pair to the client and the server, respectively.

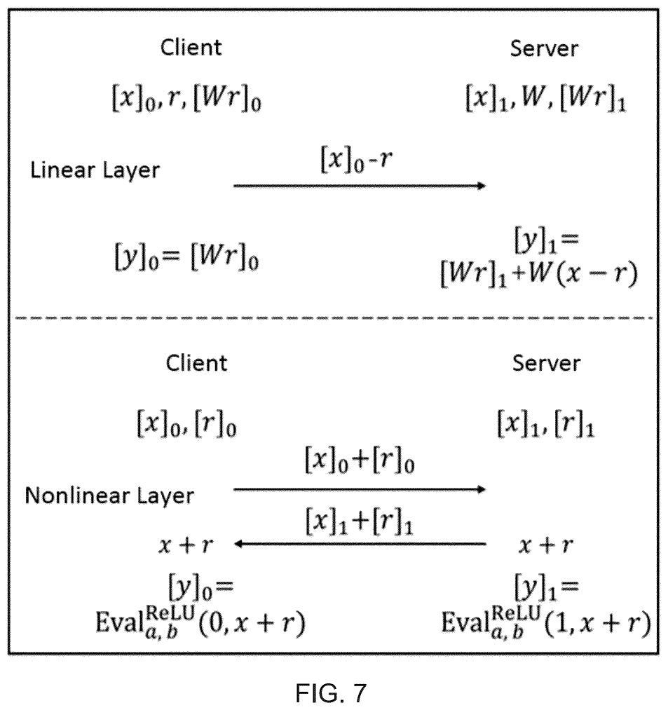

A flow of the online stage is shown in FIG. 7, which mainly includes the following two parts:
1) Linear layer: the shared W, r, and x generated in the off line stage remains unchanged. A specific operation process is as follows:
   i) The client sends [x]₀−r mod N to the server, and at the same time, [y]₀=[Wr]₀.
   ii) The server calculates x−r=[x]₀−r+[x]₁ mod and [y]₁=[Wr]₁+W(x−r)mod N.
2) Non-linear layer: taking the calculation of the ReLU function as an example, a specific operation process is as follows:
   i) The client sends [x]₀+[r]₀ mod N to the server, and the server sends [x]₁+[r]₁ mod N to the client. In this way, both parties can calculate x+r mod N. That is, x+r=[x]₀+[r]₀+[x]₁+[r]₁ mod N, and then the two parties simultaneously obtain the share value of [y]₀, [y]₁ (that is, the sharing of ReLU(x) by inputting x+r mod N through the Eval_{a,b}^{ReLU} function and/or process).

It should be noted that the r of the nonlinear layer in FIG. 7 is different from the r of the linear layer, and the r of the nonlinear layer satisfies: r=[r]₀+[r]₁ mod N.

The privacy-preserving neural network prediction system and method provided in embodiments of the present specification are efficient and privacy-preserving, and may be similar to the existing Delphi. Embodiments of the present specification are based on a pre-processing paradigm. However, compared with Delphi, the on-line stage efficiency of embodiments of the present specification is greatly improved. The effects of the privacy-preserving neural network prediction system provided by embodiments of the present specification include at least:
An efficient cryptographic protocol is set for a non-linear layer using a cryptographic technology (function secret sharing), and is improved using a unique optimization method (e.g., deep learning). Embodiments of the present specification make slight modifications to the ReLU process and/or function, reduce the number of calls of the comparison function from twice to once, and theoretically prove that the errors brought by such modifications in the evaluation of the neural network are negligible. Compared with the most efficient function secret sharing solution (e.g., in a general solution), the execution time of the online stage in these embodiments of the present specification is only half of that. In terms of communications, only one round of communication interaction is performed in embodiments of the present specification, and each party only sends n bits of data at the online stage (n represents the size of a secret shared ring). Compared with embodiments of the present specification, the communication overhead of the Delphi solution is κn bits (κ represents the security parameter), that is to say, the communication efficiency of embodiments of the present specification is improved by

$$\frac{κ}{2}$$

times, for example, if κ=128 is generally taken, the communication efficiency is improved by 64 times.
For the evaluation of the linear layer, the overhead at the online stage in embodiments of the present specification is the same as that in the Delphi solution. However, it is worth noting that the calculations in embodiments of the present specification are based on a ring rather than a domain, which naturally conforms with 32-bit or 64-bit calculations performed in the CPU.

In conclusion, compared with the existing solution(s) based on the Delphi framework, the execution time of the online stage in embodiments of the present specification is reduced to 1/14 and the communication overhead is reduced to 1/18. In addition, embodiments of the present specification also (re)customize the offline stage protocol, which not only improves the efficiency of the offline stage but also requires only a lightweight secret sharing operation. Finally, the present system is modular, and technology optimizing any of the components of the system can be directly integrated into the offline stage without affecting the online process. For example, by applying one or more embodiments of the present specification to DenseNet-121, the inferences of an ImageNet scale are securely implemented, which can complete 0.51 GB communication in 48 seconds. In comparison, the only known two-party solution that considers ImageNet-scale tasks requires approximately 8 minutes and results in a communication overhead in excess of 35 GB. The foregoing emulation application indicates that, when compared with existing solution(s) based on the Delphi framework, embodiments of the present specification greatly improve efficiency.

Finally, it should be noted that the foregoing embodiments are merely intended to describe the technical solutions of the present invention, but are not intended to limit the present specification. Although the present specification describes in detail the foregoing embodiments, persons of ordinary skill in the art should understand that they may still make modifications to the technical solutions described in the foregoing embodiments or make equivalent replacements to some technical features thereof. Such modifications or replacements do not make the essence of the corresponding technical solutions depart from the spirit and scope of the technical solutions of the embodiments or of the present specification.

The foregoing descriptions are merely exemplary embodiments of the present invention. Those skilled in the art can make modification, equivalents, replacements, or improvements without departing from the spirit and principle(s) of the present invention, all of which should fall within the protection scope of the present disclosure.

What is claimed:

1. A prediction system adapted to preserve privacy, comprising a client, a server, and a third party device, wherein:
each of the client, the server, and the third party device includes a pseudorandom number generator;
the server includes a neural network configured to specify a prediction task, and the neural network comprises one or more linear layers and one or more non-linear layers;
the client is configured to initiate a task prediction request to the server, and the server is configured to return to the client a hierarchical structure of the neural network and a type of a current network layer for a current task prediction;
the client, the server, and the third party device are configured to share a model parameter of the neural network in an offline stage of the current task prediction by:
each of the client, the server, and the third party device generating pseudorandom seeds with the others of the client, the server, and the third party device to obtain a first seed between the client and the server, a second seed between the client and the third party device, and a third seed between the server and the third party device; and
when the current network layer is one of the one or more linear layers:
the client and the third party device respectively input the second seed into a corresponding pseudorandom number generator to generate a first pseudorandom number;
either or both of the client and the third party device update the second seed according to an agreed updating strategy, and then either or both of the client and the third party device input the updated second seed into the corresponding pseudorandom number generator to generate a second pseudorandom number;
the server and the third party device respectively input the third seed into the corresponding pseudorandom number generator to generate a third pseudorandom number;
the third party device calculates first and second sharing parameters of the one linear layer from the first, second and third pseudorandom numbers and sends a result to the server;
the client and the server respectively input the first seed into the corresponding pseudorandom number generator to generate a fourth pseudorandom number;
the client calculates a random number from at least the first and fourth pseudorandom numbers; and
the server sends a value corresponding to the model parameter minus the third pseudorandom number to the client, the client locally calculates a first parameter from at least the model parameter, the second and third pseudorandom numbers, and the random number, and the server locally calculates a second parameter from the third and fourth pseudorandom numbers and the first sharing parameter; and
when the current network layer is one of the one or more non-linear layers:
the third party device generates a key pair according to an agreed function secret sharing strategy, and sends a first key of the key pair to the client and a second key of the key pair to the server, wherein:
the first key comprises a second random number jointly generated by the third party device and the client based on the second seed,
the second key comprises a third random number jointly generated by the third party device and the server based on the third seed, and
the agreed function secret sharing strategy comprises a key generation strategy of probabilistic polynomial time and an evaluation strategy of polynomial time;
the client and the server jointly execute a forward inference operation in an online stage of the prediction task using the neural network by:
the client dividing or separating to-be-predicted data into first and second parts according to a configured secret sharing equation, and sending at least a component of the second part to the server; and
the neural network is configured to carry out the forward inference operation by:
defining input data of each layer of the client, wherein the input data of a first layer of the client is the first part;
defining input data of each layer of the server, wherein the input data of a first layer of the server is the component of the second part;
when the current network layer is one of the one or more linear layers, the forward inference operation further comprises:
the client sending the input data of the linear layer and a second component of the second part to the server, and the server extracting the input data of the linear layer,
the client calculating a first output of the linear layer, and taking the first output as input data of a next layer of the client, and
the server reconstructing data of the linear layer, calculating a second output of the linear layer, and takes the second output as input data of a next layer of the server; and
when the current network layer is one of the one or more non-linear layers, the forward inference operation further comprises:
the client sending the input data of the non-linear layer of the client and a modified second random number to the server;
the server sending the input data of the non-linear layer of the server and a modified third random number to the client; and
the client and the server respectively reconstructing the data of the non-linear layer;
the client is configured to obtain the first output of a current layer using the evaluation strategy of the agreed function secret sharing strategy based on the reconstructed data and the first key or a first secret key, and take the first output as the input data of the next layer of the client;
the server is configured to obtain the second output of the current layer using the evaluation strategy of the agreed function secret sharing based on the reconstructed data and the second key or a second secret key, and take the second output as the input data of the next layer of the server;
the server is configured to return the second output of the last layer to the client when the forward inference operation is carried out on a last layer of the neural network; and
the client is configured to obtain a final prediction result based on the second output of the last layer from the server and the first output of the last layer obtained by the client.

2. The prediction system according to claim 1, wherein the third party is configured to generate the key pair according to the agreed function secret sharing policy.

3. The prediction system according to claim 2, wherein the third party generates the key pair by:
the client and the third party device respectively generating the second random number using the corresponding pseudorandom number generators based on the second seed;
the server and the third party device respectively generating the third random number using the corresponding pseudorandom number generators based on the third seed;
the third party device calculating at least one component of the reconstructed data;
the third party device defining a plurality of parameters and generating the key pair using at least a subset of the plurality of parameters as an input to an agreed generation function;
the third party device selecting a first random value and obtaining a second random value; and
the third party device generating the key pair and sending the key pair to the client and the server, respectively.

4. The prediction system according to claim 1, wherein the client and the server respectively obtain the output of the current layer through the evaluation strategy in the agreed function secret sharing strategy.

5. The prediction system according to claim 4, wherein the client and the server respectively obtain the output of the current layer by:
the client and the server respectively calculating the model parameter(s) of the current layer based on an agreed equation, wherein:
the client obtains a first pair of sharing values based on a first evaluation function or process of the evaluation strategy;
the server obtains the client obtains a second pair of sharing values based on a second evaluation function or process of the evaluation strategy; and
the evaluation function or process of the evaluation strategy is a function of polynomial time; and
the client and the server respectively calculate the first output of the client and the second output of the server using the first and second pairs of sharing values.

6. The prediction system according to claim 5, wherein the agreed equation comprises a configured secret sharing equation.

7. The prediction system according to claim 1, wherein after each of the first, second and third seeds are input into the corresponding pseudorandom number generator(s), a value of the first, second and third seeds self-increase by 1.

8. The prediction system according to claim 1, wherein the pseudorandom number generator in each of the client, the server, and the third party device is identical to the pseudorandom number generator in the others of the client, the server, and the third party device.

9. The prediction system according to claim 1, wherein the neural network comprises a plurality of the linear layers and a plurality of the non-linear layers.

10. The prediction system according to claim 1, wherein the second seed is updated in accordance with the agreed updating strategy each time the client and the third party device input the second seed into the corresponding pseudorandom number generator.

11. The prediction system according to claim 1, wherein the third seed is updated in accordance with the agreed updating strategy each time the server and the third party device input the third seed into the corresponding pseudorandom number generator.

12. The prediction system according to claim 1, wherein the linear layer corresponds to the first sharing parameter.

13. The prediction system according to claim 1, wherein the first seed is updated in accordance with the agreed updating strategy each time client and the server input the first seed into the corresponding pseudorandom number generator.

14. The prediction system according to claim 1, wherein the key pair is generated using the key generation strategy, and an input to the prediction task is evaluated using the evaluation strategy.

15. The prediction system according to claim 1, wherein the to-be-predicted data comprises image data.
